(19) United States
(12) Patent Application Publication
(10) Pub. No.: US 2010/0092693 A1
(43) Pub. Date: Apr. 15, 2010

(54) ADHESIVE COMPOSITION FOR POLARIZER AND THE PREPARATION METHOD OF POLARIZER USING THE SAME

(75) Inventors: ChanHo Park, Daejeon (KR); HyunGi Kim, Daejeon (KR); JunEui Yu, Daejeon (KR)

Correspondence Address: CANTOR COLBURN, LLP, 20 Church Street, 22nd Floor, Hartford, CT, 06103, US

(73) Assignee: OMNI CHEM CO., LTD., Daejeon (KR)

(21) Appl. No.: 12/442,893

(22) PCT Filed: Sep. 21, 2007
(86) PCT No.: PCT/KR2007/004628

§ 371 Date: Mar. 25, 2009

(30) Foreign Application Priority Data
Sep. 29, 2006 (KR) 10-2006-0095509

(51) Int. Cl. B05D 3/06; C08F 2/46; H05H 1/00; G02B 1/08

(52) U.S. Cl. 427/535; 522/64; 427/553; 359/485

(57) ABSTRACT

The present invention relates to an adhesive composition for adhesion of a polarizing film and a protecting film, a preparation method of the polarizer using the adhesive composition and a polarizer produced by the method. The adhesive composition of the present invention is a photocurable adhesive composition composed of 30-70 weight part of (metha)acrylate monomer, 25-65 weight part of acrylate oligomer, 4-10 weight part of a photoinitiator, and 0-3 weight part of an additional additive. And, the polarizer prepared by using the same has excellent flexibility, elasticity, impact resistance, adhesive strength and durability, resulting in the increase of strength and reliability as a polarizer. The preparation method of a polarizer of the present invention using the photocurable adhesive composition does not need heating and pressing processes, making the manufacturing line simple and thereby reducing costs for facilities. The method of the invention also simplifies the pretreatment process of a protecting film, resulting in the increase of production efficiency.

### TECHNICAL FIELD

The present invention relates to an adhesive composition for adhesion of a polarizing film and a protecting film, a preparation method of a polarizer using the adhesive composition and a polarizer prepared using the same.

### BACKGROUND ART

It is generally known that a polarizer is prepared by adhering a transparent protecting film (2) on the one side or both sides of a polarizing film (1) composed of polyvinyl alcohol (referred as ‘PVA’ hereinafter) based resin stained with a dichromatic dye or iodine by using an adhesive (3).

The adhesive for the preparation of a polarizer is exemplified by an acryl adhesive (Japanese Laid-Open Patent Publication No. Hei5-212828), a dry laminate adhesive which is a mixture of polyurethane resin solution and polyisocyanate resin solution, a styrene butadiene rubber adhesive, an epoxy based two liquids hard type adhesive (Japanese Laid-Open Patent Publication No. Hei6-51117), a mixture of a polyvinylalcohol based adhesive and a two liquids type adhesive (Japanese Laid-Open Patent Publication No. 2000-321430), a polyurethane based adhesive (Japanese Laid-Open Patent Publication No. 2000-321432), an adhesive comprising a polyester based ionomer type urethane resin and a compound having a glycidyloxy group (Korean Patent Publication No. 10-2005-0077018), an energy ray-curable adhesive or a thermosetting adhesive (Japanese Patent Application No. Hei6-142193), etc.

To adhere to a protecting film such as triacetyl cellulose (TAC) on the PVA based polarizing film using the above adhesive successfully, a pretreatment process is necessary before adhering a plastic film like TAC film on the polarizing film.

The pretreatment process is composed of the following steps: alkali treatment; washing; and drying. For example, for the pretreatment of a plastic film, TAC film is soaked in alkali solution for a while and then the alkali treated TAC film is washed with water, followed by drying the TAC film in a drier or using another drying apparatus.

The use of such an adhesive based on water or organic solvent reduces durability including heat resistance and moisture resistance of a polarizer, reduces the adhesive strength, causes an environmental problem such as pollution from the waste alkali solution, extends polarizer production line and thus makes the production process complicated, which makes the whole process inefficient and limits the applicable film to TAC and COP (cyclo-olefin polymer) and only some of other films.

In the case of using a thermosetting adhesive, the heat-treatment process is additionally required after adhering with the adhesive, suggesting that the production process takes longer than usual. And in that case, the PVA based polarizer is apt to be shrunken by heat or results in color changes. In case the polarizer is saved from color change or damage by heat, the productivity will be significantly reduced owing to the required long-time heat treatment.

Japanese Laid-Open Patent Publication No. JP1996-216320 describes a photocurable adhesive containing the copolymer of ethylene, vinyl acetate and acrylate and/or methacrylate monomer as a major component. Japanese Laid-Open Patent

Publication No. JP1996-216322 describes a preparation of a polarizer using a photocurable adhesive containing the copolymer of ethylene and acrylate and/or methacrylate monomer and maleic acid and/or maleic anhydride as a major component. However, the photocurable adhesive containing the copolymer as a major component has disadvantages as follows; a heating process using an electric press at 80-90° C. for 15 minutes is necessary for the production of a polarizer; and in particular in the case of using toluene for dissolving the copolymer, an evaporation process using a 50° C. oven for 1 hour and a heating process under the vacuum condition at 90° C. for 30 minutes are required. Such heating and pressing processes might cause the contraction of the PVC polarizer or color change and particularly long-time heating and pressing result in the decrease of the productivity and make the manufacturing process more complicated.

### DISCLOSURE

### Technical Problem

To overcome the above problems of the conventional method, the present inventors tried to develop an adhesive composition for adhesion of a polarizing film and a protecting film that can prevent the contraction or color change of a polarizer without pretreatment of a film and the additional heating and pressing processes. As a result, the present inventors completed this invention by developing a solvent-free photocurable adhesive that contains photocurable (metha)acrylate monomer applicable and acrylate oligomer as major components.

It is an object of the present invention to provide a photocurable adhesive composition for adhesion of a polarizing film and a protecting film, a preparation method of a polarizer using the adhesive composition and a polarizer prepared by the method.

### Technical Solution

In a preferred embodiment of the present invention, the adhesive composition for adhesion of a polarizing film and a protecting film of the invention contains 30-70 weight part of (metha)acrylate monomer, 25-65 weight part of acrylate oligomer, 4-10 weight part of a photoinitiator, and 0-3 weight part of an additive.

According to the method of the present invention, a polarizer having excellent physical properties can be produced by photocuring without additional heating or pressing.

The polarizing film herein is PVA;

The protecting film herein is selected from the group consisting of triacetyl cellulose (TAC), polyethylene terephthalate (PET), cyclo-olefin polymer (COP), acryl films and a mixture thereof;

The (metha)acrylate monomer herein is selected from the group consisting of (metha)acrylic acid, methyl(metha)acrylic acid, methyl(metha)acrylate, vinyl acrylate, 2-hydroxyethyl acrylate, 2-hydroxypropyl acrylate, 4-hydroxybutyl acrylate, N,N-dimethyl acrylamide, glycidyl methacrylate, phenoxyethyl acrylate and a mixture thereof;

The acrylate oligomer herein is selected from the group consisting of aromatic or aliphatic urethane acrylate oligomer, epoxy acrylate oligomer, polyester acrylate oligomer, silane group introduced acrylate oligomer and a mixture thereof;

The photoinitiator herein is selected from the group consisting of 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, methylbenzoylformate, 2-benzyl-2-(dimethylamino)-1-[4-(4-morpholineyl)phenyl]-1-butanone, 2-methyl-1-[4-(methylthio)phenyl]-2-(4-morpholineyl)-1-propanone, diphenyl (2,4,6-trimethylbenzoyl)-phosphineoxide, phosphineoxide phenyl bis(2,4,6-trimethyl benzoyl), bis(etha 5-2,4-cyclopentadiene-1-yl)bis[2,6-difluoro-3-(1-hydrogen-perrole-1-yl)phenyl]titanium, iodonium(4-methylphenyl)[4-(2-methylpropyl)phenyl]-hexafluorphosphate and a mixture thereof;

And the additive herein is selected from the group consisting of a photo stabilizer, a polymerization inhibitor, a dye, a pigment, silica gel micro-particles, silicon copolymer micro-particles and a mixture thereof, but not always limited thereto.

The preferable content of the (metha)acrylate monomer is 30-70 weight part for 100 weight part of the composition. If the content is less than 30 weight part or more than 70 weight parts, the strength or durability of the adhesive layer after the photocuring will be significantly reduced.

The preferable content of the acrylate oligomer is 25-65 weight part for 100 weight part of the composition. If the content is less than 25 weight part or more than 65 weight parts, the adhesive strength and durability will be significantly reduced and the transparence or optical uniformity of the adhesive layer will also be poor.

The physical properties of the laminated film and the photocuring speed will be increased, which favors the production process, if the (metha)acrylate monomer is included by 35-65 weight part, the acrylate oligomer is included by 30-60 weight part, the photoinitiator is included by 4-7 weight part, and the additional additive is included by 0-3 weight part, and more preferably the(metha)acrylate monomer is included by 50-60 weight part, the acrylate oligomer is included by 35-45 weight part, the photoinitiator is included by 4-7 weight part and the additional additive is included by 0-3 weight part.

The oligomer herein is not limited in its molecular weight, but is preferably the aromatic or aliphatic urethane acrylate oligomer having the weight average molecular weight of 2,000-20,000, the epoxy acrylate oligomer having the weight average molecular weight of 1,000-5,000, the polyester acrylate oligomer having the weight average molecular weight of 1,000-25,000, and the silane group introduced oligomer having the weight average molecular weight of 500-10,000, considering the adhesive strength, hardeniny speed and viscosity as well as workability.

The urethane acrylate oligomer herein is exemplified by EB-1259, EB-1290, EB-2001, EB-2002, EB-2003, EB-204, EB-205H, EB-210, EB-220, EB-2220, EB-230, EB-244, EB-245, EB-254, EB264, EB-265, EB-270, EB4830, EB-4833, EB-4835, EB-4842, EB-4858, EB-4866, EB-4883, EB-5129, EB-6602, EB-8200, EB8210, EB-8301, EB-8402, EB-8800, EB-8803, EB-8804, EB-9017, EB-9019, EB-9206, EB9215, EB-9216, EB-9260, EB-9264, EB-9269, EB-9270 and EB-9970 (fabricated by SK CYTEC), UX-2201, UX-2301, UX-3204, UX-3301, UX-4101, UX-6101, UX-7101, UX-8101, DPHA-40H, MU-2100 and MU4001 (fabricated by Nipponkayaku Co. Ltd.), and QU-1600, QU-1620, QU-1650, QU-1700, QU-1800, QU-1810, QU-200, QU-201, QU-2010, QU-2040, QU-2050, QU-2060, QU-2070, QU-2080, QU-2090, QU-210, QU-211, QU-220, QU-2200, QU-2300, QU-300, QU-3010, QU-3011, QU-310 and QU-700 (fabricated by QENTOP). The bisphenol-A-epoxy acrylate of the present invention is selected from the group consisting of EB-3701, EB-2958, EB-2959, EB-3600, EB-3700, EB-600, EB-9604 and EB-9608 of SK CYTEC.

The polyester acrylate oligomer herein is exemplified by EB-1657, EB-1810, EB-1870, EB-2870, EB-3438, EB-436, EB-438, EB-450, EB-505, EB-524, EB-525, EB-584, EB-585, EB-586, EB-588, EB-657, EB-770, EB-80, EB-800, EB-81, EB-810, EB-811, EB-812, EB-813, EB-83, EB-830, EB-84, EB-840, EB-850, EB-870 and EB-880 of SK CYTEC. The silane group introduced oligomer is preferably QS-500 of QENTOP. The above oligomers are only preferably examples and not always limited thereto.

The photocurable adhesive composition of the present invention can be photocured within 1-30 seconds and has excellent adhesive strength, compared with the conventional adhesives, in addition to excellent workability and durability including heat resistance and moisture resistance.

### Mode for Invention

In a preferred embodiment of the present invention, the present invention provides a preparation method of a polarizer comprising the following steps: (a) preparing a photocurable adhesive composition containing 30-70 weight part of (metha) acrylate monomer, 25-65 weight part of acrylate oligomer, 4-10 weight part of a photoinitiator, and 0-3 weight part of other additives; (b) coating the composition in between a polarizing film and a protecting film, followed by extruding; and (c) performing photocuring by photoirradiating the extruded polarizer.

The adhesive composition used in the preparation method contains 35-65 weight part of (metha)acrylate monomer, 30-60 weight part of acrylate oligomer, 4-7 weight part of a photoinitiator, and 0-3 weight part of an additive. More preferably, the adhesive composition contains 50-60 weight part of (metha)acrylate monomer, 35-45 weight part of acrylate oligomer, 4-7 weight part of a photoinitiator, and 0-3 weight part of an additive.

The polarizing film herein is PVA;

The protecting film herein is selected from the group consisting of TAC, PET, COP, acryl films and a mixture thereof;

The (metha)acrylate monomer herein is selected from the group consisting of (metha)acrylic acid, methyl(metha)acrylic acid, methyl(metha)acrylate, vinyl acrylate, 2-hydroxyethyl acrylate, 2-hydroxypropyl acrylate, 4-hydroxybutyl acrylate, N,N-dimethyl acrylamide, glycidyl methacrylate, phenoxyethyl acrylate and a mixture thereof;

The acrylate oligomer herein is selected from the group consisting of aromatic or aliphatic urethane acrylate oligomer, epoxy acrylate oligomer, polyester acrylate oligomer, silane group introduced acrylate oligomer and a mixture thereof;

The photoinitiator herein is selected from the group consisting of 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, methylbenzoylformate, 2-benzyl-2-(dimethylamino)-1-[4-(4-morpholineyl)phenyl]-1-butanone, 2-methyl-1-[4-(methylthio)phenyl]-2-(4-morpholineyl)-1-propanone, diphenyl(2,4,6-trimethylbenzoyl)-phosphineoxide, phosphineoxide phenyl bis(2,4,6-trimethyl benzoyl), bis(etha 5-2,4-cyclopentadiene-1-yl)bis[2,6-difluoro-3-(1-hydrogen-perrole-1-yl)phenyl]titanium, iodonium(4-methylphenyl) [4-(2-methylpropyl)phenyl]-hexafluorphosphate and a mixture thereof;

The additive herein is selected from the group consisting of a photo stabilizer, a polymerization inhibitor, a dye, a pigment, silicagel micro-particles, silicon copolymer micro-particles and a mixture thereof, but not always limited thereto.

Preferably, the aromatic or aliphatic urethane acrylate oligomer has the weight average molecular weight of 2,000-5,000: the epoxy acrylate oligomer has the weight average molecular weight of 3,000-7,000: the polyester acrylate oligomer has the weight average molecular weight of 500-3,500: and the silane group introduced oligomer has the weight average molecular weight of 2,500-4,500.

The urethane acrylate oligomer herein is exemplified by EB-1259, EB-1290, EB-2001, EB-2002, EB-2003, EB-204, EB-205H, EB-210, EB-220, EB-2220, EB-230, EB-244, EB-245, EB-254, EB264, EB-265, EB-270, EB4830, EB-4833, EB-4835, EB-4842, EB-4858, EB-4866, EB-4883, EB-5129, EB-6602, EB-8200, EB8210, EB-8301, EB-8402, EB-8800, EB-8803, EB-8804, EB-9017, EB-9019, EB-9206, EB9215, EB-9216, EB-9260, EB-9264, EB-9269, EB-9270 and EB-9970 (SK CYTEC), UX-2201, UX-2301, UX-3204, UX-3301, UX-4101, UX-6101, UX-7101, UX-8101, DPHA-40H, MU-2100 and MU4001 (Nipponkayaku Co. Ltd.), and QU-1600, QU-1620, QU-1650, QU-1700, QU-1800, QU-1810, QU-200, QU-201, QU-2010, QU-2040, QU-2050, QU-2060, QU-2070, QU-2080, QU-2090, QU-210, QU-211, QU-220, QU-2200, QU-2300, QU-300, QU-3010, QU-3011, QU-310 and QU-700 (QENTOP). The bisphenol-A-epoxy acrylate of the present invention is selected from the group consisting of EB-3701, EB-2958, EB-2959, EB-3600, EB-3700, EB-600, EB-9604 and EB-9608 of SK CYTEC.

The polyester acrylate oligomer herein is exemplified by EB-1657, EB-1810, EB-1870, EB-2870, EB-3438, EB-436, EB-438, EB-450, EB-505, EB-524, EB-525, EB-584, EB-585, EB-586, EB-588, EB-657, EB-770, EB-80, EB-800, EB-81, EB-810, EB-811, EB-812, EB-813, EB-83, EB-830, EB-84, EB-840, EB-850, EB-870 and EB-880 of SK CYTEC. The silane group introduced oligomer is preferably QS-500 of QENTOP. The above oligomers are only preferably examples and not always limited thereto.

The preparation method above is described in more detail. Step (a) of the preparation method of a polarizer of the invention is to prepare a photocurable adhesive composition, in which 4-10 weight part of a photoinitiator and 0-3 weight part of other additives (for 100 weight part of the whole composition) are dissolved in 30-70 weight part of liquid (metha)acrylate monomer in a stirrer, to which 25-65 weight part of acrylate oligomer is added, followed by stirring for complete dissolution and as a result a photocurable adhesive composition is prepared.

For the preparation of the photocurable adhesive composition of the invention, the ratio of (metha)acrylate monomer to acrylate oligomer is very important and the amount of a photoinitiator is preferably regulated fewer than 10% for the total amount of the (metha)acrylate monomer and acrylate oligomer. When the ratio of (metha)acrylate monomer and acrylate oligomer is regulated with the acceptable range provided by the present invention, a polarizer having improved excellent physical properties including adhesive strength, heat resistance, moisture resistance, flexibility and impact resistance will be prepared.

Step (b) of the preparation method of a polarizer of the present invention is to load the composition of step (a) in between a polarizing film and a protecting film for coating, followed by extrusion, in which the coating method is selected from the group consisting of gravure coating, micro-gravure coating, casting method, meyer bar coating, die coating, dip coating, knife coating, air coating, slot die coating, bar coating and roll coating, but not always limited thereto. Among the coating methods, gravure coating, knife coating or slot die coating is preferred for the process. One side of the protecting film is first coated with the composition and then pressed by a press roll, leading to lamination and extrusion, which proceeds to the UV irradiation area located in rear of the press roll, followed by photocuring by UV. All the processes are performed at room temperature. The thickness of the adhesive coating is 5-10 m per unit area and coating speed is preferably 10 m/min, but these conditions can be properly regulated.

Step (c) of the preparation method of a polarizer of the present invention is to irradiate light on the extruded polarizer for photocuring. A mercury lamp or a metal-halide lamp is used for the irradiation. Irradiation time is 1-30 seconds and quantity of the light is 250-1500 mJ/cm². Preferably, photocuring is performed with a mercury lamp by irradiating for up to 10 seconds by 500 mJ/cm².

In step (c), it is also possible to irradiate the adhesive layer on the polarizing film and the protecting film with plasma, corona, and UV or to use a framed film to increase adherence of the polarizing film or the protecting film.

In the above process, the use of the adhesive composition containing the monomer, acryl oligomer and a initiator according to the present invention for the curing brings more than expected effects; such as increase of durability and adhesive strength of the film, which favors long-term use or high temperature-high humidity durability, and less chance of distortion or irregular surface during the curing of the adhesive on the film, meaning the film maintains its shape constantly.

If the ratio of the monomer to the oligomer is regulated as the mentioned range and if the mixture of urethane acrylate oligomer and epoxy acrylate oligomer is used as the oligomer above, more preferably if urethane acrylate oligomer and epoxy acrylate oligomer are mixed at the weight ratio of 25-75:75-25, the epoxy acrylate oligomer can contribute to the increase of adhesive strength to PVA film, the material of a polarizing film, and the urethane acrylate oligomer can improve the adhesive strength to TAC film, acryl film or COP film, the material of a protecting film.

In a preferred embodiment of the invention, the present invention provides a polarizer prepared by the preparation method of a polarizer of the invention. The polarizer of the present invention is characterized by excellent, improved physical properties including adhesive strength, heat resistance, moisture resistance, flexibility and impact resistance.

The photocurable adhesive composition of the invention for adhesion of a polarizing film and a protecting film can attach the polarizing film to the protecting film by high-speed curing, so the resultant polarizer can have improved flexibility, elasticity, impact resistance, adhesive power and durability, suggesting that the polarizer is more reliable in strength and reliability.

The preparation method of a photocurable adhesive composition of the present invention has advantages of simplifying the polarizer manufacturing line by excluding heating and pressing processes, reduction of the costs for property and facilities and energy consumption, efficiency owing to the reduced production time, minimizing the heat-contraction or color change of a PVA based polarizing film, simplifying the pretreatment process of a protecting film, and the increase of production efficiency, thereby.

The polarizer can also be prepared by using the conventional TAC, COP, and other films as a protecting film herein.

The preparation method of a polarizer of the invention is pro-environmental since a solvent-free adhesive is used for the preparation of a polarizer to reduce environmental pollution.

### Best Mode

Hereinafter, the embodiments of the present invention will be described in detail with reference to accompanying drawings.

### EXAMPLES 1˜6

The photocurable adhesive compositions of the invention were prepared according to the compositions and contents shown in Table 1. First, a photoinitiator and other additives were completely dissolved in liquid monomer by a high-speed stirrer. Then, acrylate oligomer was added thereto, followed by complete dissolving using a high-speed stirrer.

TABLE 1

| | | | | | | | | comparative example | | | | | |
|---|---|---|---|---|---|---|---|---|---|---|---|---|---|
| adhesive | | Example (unit: g) | | | | | | (unit: g) | | | | | |
| composition | | 1 | 2 | 3 | 4 | 5 | 6 | 1 | 2 | 3 | 4 | 5 | 6 |
| (metha)acrylate | MMA | 35 | 35 | 35 | 20 | 20 | 20 | 20 | 85 | 50 | | 35 | |
| monomer | 2-HEA | 20 | | | 35 | | | | | 20 | | 20 | |
| | PEA | | 20 | | | 35 | | | | 20 | | | |
| | VA | | | 20 | | | 35 | | | 5 | | | |
| acrylate oligomer | UX-2201 | 15 | 15 | 15 | 15 | 15 | 15 | 45 | 5 | | 50 | | 15 |
| | EB-3701 | 25 | 25 | 25 | 25 | 25 | 25 | 30 | 5 | | 45 | | 25 |
| initiator | TPO | 5 | 5 | 5 | 5 | 5 | 5 | 5 | 5 | 5 | 5 | 3 | 3 |

MMA: methylmethacrylate, SAMCHUN PURE CHEM, CO., LTD
2-HEA: 2-hydroxy ethyl acrylate, SAMCHUN PURE CHEM, CO., LTD
PEA: phenoxy ethyl acrylate, SAMCHUN PURE CHEM, CO., LTD
VA: vinyl acrylate, Aldrich
UX-2201: urethane acrylate oligomer, Nipponkayaku Co. Ltd.
EB-3701: bisphenol-A epoxy acrylate, SK CYTEC
TPO: 2,4,6-triethylbenzoyldiphenylphosphine oxide, Ciba

TAC protecting film was coated evenly with the prepared adhesive composition by using a coating machine according to micro-gravure coating method, followed by laminating with PVA polarizing film. Extrusion was performed using a lamination extruder, resulting in a polarizer. Then, photocuring was performed with a mercury lamp by irradiating for up to 10 seconds by 500 mJ/cm² to produce the polarizer.

### COMPARATIVE EXAMPLES 1˜6

The photocurable adhesive compositions were prepared by the same manner as described in Examples 1˜6 according to the compositions shown in the section of Comparative Example 1˜6 in Table 1, and polarizers were prepared by using the compositions, PVA polarizing films and TAC protecting films.

### EXAMPLES 7˜9

The photocurable adhesive compositions were prepared by using 55 g of (metha)acrylate monomer and 5 g of a initiator, which were in common among the compositions, and different amounts of acrylate oligomer (30 g, 50 g and 60 g, respectively) (Table 2) by the same manner as described in Examples 1˜6. Polarizers were prepared by using the compositions, PVA polarizing films and TAC protecting films.

TABLE 2

| | | Example (unit: g) | | |
|---|---|---|---|---|
| adhesive composition | | 7 | 8 | 9 |
| (metha)acrylate | MMA | 14 | 14 | 14 |
| monomer | 2-HEA | 15 | 15 | 15 |
| | PEA | 11 | 11 | 11 |
| | VA | 10 | 10 | 10 |
| acrylate | UX- | 13 | 23 | 27 |
| oligomer | 2201 | | | |
| | EB- | 17 | 27 | 33 |
| | 3701 | | | |
| initiator | TPO | 5 | 5 | 5 |

### EXAMPLES 10˜13

The photocurable adhesive compositions were prepared by using 35 g of (metha)acrylate monomer and 5 g of a initiator, which were in common among the compositions, and different amounts of acrylate oligomer (30 g, 40 g, 50 g and 60 g, respectively) (Table 3) by the same manner as described in Examples 1˜6. Polarizers were prepared by using the compositions, PVA polarizing films and TAC protecting films.

TABLE 3

Example (unit: g)

| | | | | |
|---|---|---|---|---|
| adhesive composition | 10 | 11 | 12 | 13 |

| | | | | | |
|---|---|---|---|---|---|
| (metha)acrylate | MMA | 10 | 10 | 10 | 10 |
| monomer | 2-HEA | 10 | 10 | 10 | 10 |
| | PEA | 8 | 8 | 8 | 8 |
| | VA | 7 | 7 | 7 | 7 |
| acrylate | UX- | 18 | 23 | 36 | 41 |
| oligomer | 2201 | | | | |
| | EB- | 12 | 17 | 14 | 19 |
| | 3701 | | | | |
| initiator | TPO | 5 | 5 | 5 | 5 |

### EXAMPLES 14˜17

The photocurable adhesive compositions were prepared by using 45 g of (metha)acrylate monomer and 5 g of a initiator, which were in common among the compositions, and different amounts of acrylate oligomer (30 g, 40 g, 50 g and 60 g, respectively) (Table 4) by the same manner as described in Examples 1˜6. Polarizers were prepared by using the compositions, PVA polarizing films and TAC protecting films.

TABLE 4

Example (unit: g)

| | | | | |
|---|---|---|---|---|
| adhesive composition | 14 | 15 | 16 | 17 |

| | | | | | |
|---|---|---|---|---|---|
| (metha)acrylate | MMA | 13 | 13 | 13 | 13 |
| monomer | 2-HEA | 12 | 12 | 12 | 12 |
| | PEA | 10 | 10 | 10 | 10 |
| | VA | 10 | 10 | 10 | 10 |
| acrylate | UX- | 18 | 23 | 36 | 41 |
| oligomer | 2201 | | | | |
| | EB- | 12 | 17 | 14 | 19 |
| | 3701 | | | | |
| initiator | TPO | 5 | 5 | 5 | 5 |

### EXAMPLES 18˜21

The photocurable adhesive compositions were prepared by using 65 g of (metha)acrylate monomer and 5 g of a initiator, which were in common among the compositions, and different amounts of acrylate oligomer (30 g, 40 g, 50 g and 60 g, respectively) (Table 5) by the same manner as described in Examples 1˜6. Polarizers were prepared by using the compositions, PVA polarizing films and TAC protecting films.

TABLE 5

Example (unit: g)

| | | | | |
|---|---|---|---|---|
| adhesive composition | 18 | 19 | 20 | 21 |

| | | | | | |
|---|---|---|---|---|---|
| (metha)acrylate | MMA | 15 | 15 | 15 | 15 |
| monomer | 2-HEA | 20 | 20 | 20 | 20 |
| | PEA | 15 | 15 | 15 | 15 |
| | VA | 15 | 15 | 15 | 15 |
| acrylate | UX-2201 | 18 | 23 | 36 | 41 |
| oligomer | | | | | |
| | EB-3701 | 12 | 17 | 14 | 19 |
| initiator | TPO | 5 | 5 | 5 | 5 |

### EXAMPLES 22˜23

The photocurable adhesive compositions were prepared by using 65 g of (metha)acrylate monomer, 5 g of an initiator, 40 g of acrylate oligomer and less than 3 g of a photo stabilizer by the same manner as described in Examples 1˜6 (Table 6). Polarizers were prepared by using the compositions, PVA polarizing films and TAC protecting films.

TABLE 6

Example
(unit: g)

| | | |
|---|---|---|
| adhesive composition | 22 | 23 |

| | | | |
|---|---|---|---|
| (metha)acrylate | MMA | 15 | 15 |
| monomer | 2-HEA | 20 | 20 |
| | PEA | 15 | 15 |
| | VA | 15 | 15 |
| acrylate | UX- | 23 | 23 |
| oligomer | 2201 | | |
| | EB- | 17 | 17 |
| | 3701 | | |
| initiator | TPO | 5 | 5 |
| additive | PR-25 | 1 | 3 |

PR-25: photostabilizer, Clariant Co.

### EXAMPLES 24˜33

Polarizers were prepared by using the adhesive composition of Example 4 and different kinds of protecting films shown in Table 7. Coating method was the one used in Examples 1˜6. COP and PET films were pretreated with corona.

TABLE 7
Example

| 24 | 25 | 26 | 27 | 28 | 29 | 30 | 31 | 32 | 33 |
|---|---|---|---|---|---|---|---|---|---|
| T/ | T/ | T/ | T/ | A/ | A/ | A/ | P/ | P/ | C/ |
| P*/T | P*/P | P*/A | P*/C | P*/P | P*/A | P*/C | P*/P | P*/C | P*/C |

T: TAC film,
P: PET film,
A: acryl film,
C: COP film,
P*: PVA based polarizing film

### EXPERIMENTAL EXAMPLE 1

### Adhesive Strength and Durability in 60° C. Warm Water of the Polarizer Prepared by the Photocurable Adhesive Composition of the Invention

The polarizer sample prepared in 30 mm×30 mm size was tested for adhesive strength and durability in 60° C. warm water.

First, adhesive strength in 60° C. warm water was evaluated. The polarizer samples were prepared in 30 mm×30 mm size from the polarizers prepared in Examples 1˜23 and Comparative Examples 1˜6, which were soaked in 60° C. water bath for 3 hours. After taking them out, they were separated by hand.

Adhesive strength and durability were investigated by 60° C. warm water test. Particularly, the samples were dipped in 60° C. water bath for 5 hours. After taking out, the samples were dried at room temperature, and observed by the naked eye to measure the detachment between the protecting film and the polarizer. The evaluation results were presented as ‘good’ and ‘no good’. Precisely, ‘good’ indicated no detachment or wafting was observed on the entire surface area of the protecting film and the polarizing film, and ‘no good’ indicated detachment was observed over the entire surface of the two films, disqualifying the polarizer.

The results of adhesive strength and durability tests of the polarizers of Examples 1˜23 and Comparative Examples 1˜6 performed by 60° C. warm water test are shown in Table 8 and Table 9.

TABLE 8

| physical | | | | | | | | | | | | |
|---|---|---|---|---|---|---|---|---|---|---|---|---|
| property | | | | | | | | | | | | |
| of | Example | | | | | | comparative example | | | | | |
| polarizer | 1 | 2 | 3 | 4 | 5 | 6 | 1 | 2 | 3 | 4 | 5 | 6 |
| Adhesive | Good | Good | Good | Good | Good | Good | No | No | No | No | No | No |
| strength | | | | | | | Good | Good | Good | Good | Good | Good |
| Durability | Good | Good | Good | Good | Good | Good | No | No | No | No | No | No |
| | | | | | | | Good | Good | Good | Good | Good | Good |

TABLE 9

| physical | | | | | | | | | |
|---|---|---|---|---|---|---|---|---|---|
| property | | | | | | | | | |
| of | Example | | | | | | | | |
| polarizer | 7 | 8 | 9 | 10 | 11 | 12 | 13 | 14 | 15 |
| adhesive | GOOd | GOOd | GOOd | GOOd | GOOd | GOOd | GOOd | GOOD | GOOD |
| strength | | | | | | | | | |
| durability | GOOd | GOOd | GOOd | GOOd | GOOd | GOOd | GOOd | GOOd | GOOd |

| physical property of | Example | | | | | | | |
|---|---|---|---|---|---|---|---|---|
| polarizer | 16 | 17 | 18 | 19 | 20 | 21 | 22 | 23 |
| adhesive strength | GOOD | GOOd | GOOD | GOOd | GOOD | GOOd | GOOD | GOOd |
| durability | GOOd | GOOd | GOOd | GOOd | GOOd | GOOd | GOOd | GOOd |

### EXPERIMENTAL EXAMPLE 2

### Adhesive Strength and Durability of the Polarizers Prepared by Using Different Protecting Films Investigated by 60° C. Warm Water Test

Adhesive strength and durability of the polarizers of Examples 24˜33 were investigated by 60° C. warm water test. The experiments for the investigation of adhesive strength and durability in 60° C. warm water were performed by the same manner as described in Experimental Example 1. The results are shown in Table 10.

TABLE 10

| | Example | | | | | | | | | |
|---|---|---|---|---|---|---|---|---|---|---|
| | 24 | 25 | 26 | 27 | 28 | 29 | 30 | 31 | 32 | 33 |
| | T/P*/T | T/P*/P | T/P*/A | T/P*/C | A/P*/P | A/P*/A | A/P*/C | P/P*/P | P/P*/C | C/P*/C |
| adhesive | good | good | good | good | good | good | good | good | good | good |
| strength | | | | | | | | | | |
| durability | good | good | good | good | good | good | good | good | good | good |

T: TAC film,
P: PET film,
A: acryl film,
C: COP film,
P*: PVA based polarizing film

As shown in Table 10, the polarizers prepared by the method of the invention exhibited excellent water-resistant adhesive strength and durability even with different protecting films. The water-resistant adhesive strength and durability of such a polarizer film using corona pretreated COP film and PET film were also excellent.

### EXPERIMENTAL EXAMPLE 3

### Adhesive Strength, Heat Resistance, Moisture Resistance and Durability of the Polarizer Prepared by Using the Photocurable Adhesive Composition of the Present Invention Investigated by Tensile Strength Test

Tensile strength of each polarizer was measured to evaluate adhesive strength of the polarizer. Precisely, fracture strength was measured using adhesive compositions of Examples 1˜21 and Comparative Examples 1˜6. PVA was prepared in 25 mm×25 mm size and the protecting film was prepared in 25 mm×60 mm size. The protecting film was overlapped the PVA by 25 mm×25 mm to prepare a polarizer according to the method described in Example 1. Fracture strength of the adhesive area was measured by using the universal testing machine (INSTRON, model 4465, weight 5 kg, Static Load Cell 5 kN, Speed 100 mm/min).

Heat resistance, moisture resistance and durability were also tested. The polarizers prepared above were prepared in 30 mm×30 mm size, which stood for one hour (80° C., 90.5% of RH), and then dried at room temperature. The contraction and decolorization of the sample PVA polarizers were investigated and the results are shown in table 11 and Table 12. The contraction was measured by using a caliper. Decolorization was presented by ‘yes’ indicating color change and ‘no’ indicating no-color change.

TABLE 11

| physical | | | | | | | | | | | | |
|---|---|---|---|---|---|---|---|---|---|---|---|---|
| property | | | | | | | | | | | | |
| of | Example | | | | | | Comparative example | | | | | |
| polarizer | 1 | 2 | 3 | 4 | 5 | 6 | 1 | 2 | 3 | 4 | 5 | 6 |
| fracture | 25.65 | 25.01 | 25.89 | 25.04 | 25.77 | 25.07 | 5.03 | 6.07 | 5.83 | 8.33 | 3.12 | 4.53 |
| strength | | | | | | | | | | | | |
| (kgf) | | | | | | | | | | | | |
| Contraction | 0.83 | 0.81 | 0.82 | 0.65 | 0.84 | 0.95 | 1.44 | 1.51 | 1.63 | 1.58 | 2.02 | 1.23 |
| (mm) | | | | | | | | | | | | |
| Decolorization | no | no | no | no | no | no | no | yes | yes | no | yes | no |

Fracture strength of TAC is 25 kgf.
The numbers of examples indicate fracture strength of TAC not of adhesive region.
The numbers of comparative examples indicate fracture strength of the adhesive surface.

From the above results, it was confirmed that the polarizers of Examples 1˜6 prepared by using the adhesive composition of the present invention had higher fracture strength than that of TAC (25 kgf) and the contraction less than 1 mm. Thus, it was suggested that the polarizer of the invention had excellent adhesive strength and durability owing to the improved fracture strength and prevention of contraction, compared with those of Comparative Examples 1˜6.

TABLE 12

| Physical | | Fracture | | | |
|---|---|---|---|---|---|
| property of | | strength | Contraction | | |
| polarizer | | (kgf) | (mm) | decolorization | |
| Example | 7 | 25.03 | 0.85 | No | Fracture |
| | 8 | 25.08 | 0.84 | No | strength |
| | 9 | 25.51 | 0.76 | No | of TAC is |
| | 10 | 25.95 | 0.95 | No | 25 kgf. |
| | 11 | 25.31 | 0.85 | No | The |
| | 12 | 25.98 | 0.73 | No | numbers |
| | 13 | 25.87 | 0.94 | No | of |
| | 14 | 25.01 | 0.90 | No | examples |
| | 15 | 25.43 | 0.89 | No | indicate |
| | 16 | 25.99 | 0.87 | No | fracture |
| | 17 | 25.33 | 0.96 | No | strength |
| | 18 | 25.11 | 0.88 | No | of TAC |
| | 19 | 25.89 | 0.99 | No | not of |
| | 20 | 25.51 | 0.86 | No | adhesive |
| | 21 | 25.77 | 0.91 | No | region. |
| | 22 | 25.65 | 0.87 | No | |
| | 23 | 25.58 | 0.76 | No | |

Again, the polarizer prepared by using the adhesive composition of the invention has been confirmed to have higher fracture strength than TAC (25 kgf) but less contraction than the polarizer of Comparative Example, suggesting that the polarizer of the invention has excellent adhesive strength and durability.

### EXPERIMENTAL EXAMPLE 4

### Adhesive Strength, Heat Resistance, Moisture Resistance and Durability of the Polarizers of the Present Invention Using Different Protecting Films Investigated by Tensile Strength Test

To evaluate adhesive strength, heat resistance, moisture resistance and durability of the polarizers of Examples 24˜33, fracture strength, contraction and decolorization of them were investigated. Experiments were performed by the same manner as described in Experimental Example 3 and the results are shown in Table 13.

TABLE 13

| | Example | | | | | | | | | |
|---|---|---|---|---|---|---|---|---|---|---|
| | 24 | 25 | 26 | 27 | 28 | 29 | 30 | 31 | 32 | 33 |
| | T/ | T/ | T/ | T/ | A/ | A/ | A/ | P/ | P/ | C/ |
| | P*/T | P*/P | P*/A | P*/C | P*/P | P*/A | P*/C | P*/P | P*/C | P*/C |
| fracture | 25.01 | 25.03 | 15.30 | 16.04 | 16.87 | 15.30 | 15.47 | 50 | 16.52 | 16.04 |
| strength | | | | | | | | or | | |
| (kgf) | | | | | | | | more | | |
| Contraction | 0.66 | 0.70 | 0.83 | 0.78 | 0.65 | 0.74 | 0.87 | 0.72 | 0.82 | 0.66 |
| (mm) | | | | | | | | | | |
| Decolorization | No | No | No | No | No | No | No | No | No | No |

Fracture strength-TAC(T): 25,
Acryl(A): 15,
PET(P): 50 or more,
COP(C): 16
The numbers indicate fracture strength of the protecting film.

As a result, the polarizers were confirmed to have higher fracture strength than each protecting film and less contraction than the polarizer of Comparative Example and no decolorization. This result indicates that the polarizer using acryl, PET or COP film has as good adhesive strength and durability as the polarizer using TAC.

Therefore, the adhesive composition of the present invention is applicable not only to TAC but also to various protecting films such as acryl, PET or COP film and can contribute to the production of a polarizer with improved properties.

### INDUSTRIAL APPLICABILITY

The adhesive composition for adhesion of a polarizing film and a protecting film of the invention is a photocurable adhesive. And, the polarizer prepared using the composition has excellent adhesive strength and durability, resulting in the increase of strength or liability of the polarizer.

In addition, when the photocurable adhesive composition of the present invention is used, the heating and pressing processes are not necessary, suggesting that the use of the composition makes the manufacturing line simple and thereby reduces costs for space and facilities, and makes the pretreatment of a protecting film simple and finally increases the production efficiency.

The composition of the invention can also be applied to various protecting films including TAC and COP for the production of a polarizer.

What is claimed is:

1. A photocurable adhesive composition for adhesion of a polarizing film and a protecting film comprising 30-70 weight part of (metha)acrylate monomer, 25-65 weight part of acrylate oligomer, 4-10 weight part of a photoinitiator and 0-3 weight part of an additional additive.

2. The photocurable adhesive composition for adhesion of a polarizing film and a protecting film according to claim 1, wherein the (metha)acrylate monomer is included by 35-65 weight part, the acrylate oligomer is included by 30-60 weight part, the photoinitiator is included by 4-7 weight part and the additional additive is included by 0-3 weight part; and
the polarizing film is PVA;
the protecting film is selected from the group consisting of TAC, PET, COP, acryl films and a mixture thereof;
the (metha)acrylate monomer is selected from the group consisting of (metha)acrylic acid, methyl(metha)acrylic acid, methyl(metha)acrylate, vinyl acrylate, 2-hydroxyethyl acrylate, 2-hydroxypropyl acrylate, 4-hydroxybutyl acrylate, N,N-dimethyl acrylamide, glycidyl methacrylate, phenoxyethyl acrylate and a mixture thereof;
the acrylate oligomer is selected from the group consisting of aromatic or aliphatic urethane acrylate oligomer, epoxy acrylate oligomer, polyester acrylate oligomer, silane group introduced acrylate oligomer and a mixture thereof;
the photoinitiator is selected from the group consisting of 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, methylbenzoylformate, 2-benzyl-2-(dimethylamino)-1-[4-(4-morpholineyl)phenyl]-1-butanone, 2-methyl-1-[4-(methylthio)phenyl]-2-(4-morpholineyl)-1-propanone, diphenyl(2,4,6-trimethylbenzoyl)-phosphineoxide, phosphineoxide phenyl bis(2,4,6-trimethyl benzoyl), bis(etha 5-2,4-cyclopentadiene-1-yl)bis[2,6-difluoro-3-(1-hydrogen-perrole-1-yl)phenyl]titanium, iodonium(4-methylphenyl)[4-(2-methylpropyl)phenyl]-hexafluorphosphate and a mixture thereof; and
the additive is selected from the group consisting of a photo stabilizer, a polymerization inhibitor, a dye, a pigment, silicagel micro-particles, silicon copolymer micro-particles and a mixture thereof.

3. The photocurable adhesive composition for adhesion of a polarizing film and a protecting film according to claim 1, wherein the aromatic or aliphatic urethane acrylate oligomer has the weight average molecular weight of 2,000-20,000, the epoxy acrylate oligomer has the weight average molecular weight of 1,000-5,000, the polyester acrylate oligomer has the weight average molecular weight of 1,000-25,000, and the silane group introduced oligomer has the weight average molecular weight of 500-10,000.

4. The photocurable adhesive composition for adhesion of a polarizing film and a protecting film according to claim 1, wherein the oligomer is the mixture of 25-75 weight % of aromatic or aliphatic urethane acrylate oligomer and 75-25 weight % of epoxy acrylate oligomer.

5. A preparation method of a polarizer comprising the following steps:
(a) preparing a photocurable adhesive composition for adhesion of a polarizing film and a protecting film comprising 30-70 weight part of (metha)acrylate monomer, 25-65 weight part of acrylate oligomer, 4-10 weight part of a photoinitiator, and 0-3 weight part of an additive;
(b) coating the composition in between a polarizing film and a protecting film, followed by extruding; and
(c) performing photocuring by photoirradiating the extruded polarizer.

6. The preparation method of a polarizer according to claim 5, wherein the composition contains 35-65 weight part of (metha)acrylate monomer, 30-60 weight part of acrylate oligomer, 4-7 weight part of a photoinitiator and 0-3 weight part of an additive; and
the polarizing film is PVA;
the protecting film is selected from the group consisting of TAC, PET, COP, acryl films and a mixture thereof;
the (metha)acrylate monomer is selected from the group consisting of (metha)acrylic acid, methyl(metha)acrylic acid, methyl(metha)acrylate, vinyl acrylate, 2-hydroxyethyl acrylate, 2-hydroxypropyl acrylate, 4-hydroxybutyl acrylate, N,N-dimethyl acrylamide, glycidyl methacrylate, phenoxyethyl acrylate and a mixture thereof;
the acrylate oligomer is selected from the group consisting of aromatic or aliphatic urethane acrylate oligomer, epoxy acrylate oligomer, polyester acrylate oligomer, silane group introduced oligomer and a mixture thereof;
the photoinitiator is selected from the group consisting of 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, methylbenzoylformate, 2-benzyl-2-(dimethylamino)-1-[4-(4-morpholineyl)phenyl]-1-butanone, 2-methyl-1-[4-(methylthio)phenyl]-2-(4-morpholineyl)-1-propanone, diphenyl(2,4,6-trimethylbenzoyl)-phosphineoxide, phosphineoxide phenyl bis(2,4,6-trimethyl benzoyl), bis(etha 5-2,4-cyclopentadiene-1-yl)bis[2,6-difluoro-3-(1-hydrogen-perrole-1-yl)phenyl]titanium, iodonium(4-methylphenyl)[4-(2-methylpropyl)phenyl]-hexafluorphosphate and a mixture thereof; and
the additive is selected from the group consisting of a photo stabilizer, a polymerization inhibitor, a dye, a pigment, silicagel micro-particles, silicon copolymer micro-particles and a mixture thereof.

7. The preparation method of a polarizer according to claim 6, wherein the aromatic or aliphatic urethane acrylate oligomer has the weight average molecular weight of 2,000-5,000, the epoxy acrylate oligomer has the weight average molecular weight of 3,000-7,000, the polyester acrylate oligomer has the weight average molecular weight of 500-3,500, and the silane group introduced oligomer has the weight average molecular weight of 2,500-4,500.

8. The preparation method of a polarizer according to claim 7, wherein the protecting film in step (b) is pretreated by irradiation with plasma, corona or UV or framed.

9. A polarizer prepared by one of the methods of claim 5, which is characterized by improved adhesive strength, heat resistance, moisture resistance and durability.

10. A polarizer prepared by one of the methods of claim 6, which is characterized by improved adhesive strength, heat resistance, moisture resistance and durability.

11. A polarizer prepared by one of the methods of claim 7, which is characterized by improved adhesive strength, heat resistance, moisture resistance and durability.

12. A polarizer prepared by one of the methods of claim 8, which is characterized by improved adhesive strength, heat resistance, moisture resistance and durability.
